(19) United States
(12) Patent Application Publication
(10) Pub. No.: US 2006/0084387 A1
(43) Pub. Date: Apr. 20, 2006

(54) Method and system for suppressing unwanted responses in wireless communication systems

(75) Inventor: Robert A. DiFazio, Greenlawn, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/023,766

(22) Filed: Dec. 28, 2004

Related U.S. Application Data
(60) Provisional application No. 60/619,641, filed on Oct. 18, 2004.

(51) Int. Cl. H04B 15/00; H04B 1/00

(52) U.S. Cl. 455/63.4; 455/63.1

(57) ABSTRACT

A method and system is disclosed for suppressing unwanted responses in wireless communication systems. The system comprises a transmitting terminal and a receiving terminal. The transmitting terminal comprises an antenna array including a primary antenna and a secondary antenna. The primary and secondary antennas are configured so that signals transmitted from the antennas are distinguishable to a receiving terminal. The receiving terminal comprises a receiver configured to receive signals transmitted from the antennas and compare a quality of the signals in order to determine whether a received signal was transmitted from within a main lobe of a beam of a primary antenna. The receiving terminal processes a received signal where it is determined that the received signal was transmitted from a main lobe of a beam of a primary antenna.

### CROSS REFERENCE TO RELATED APPLICATION(S)

This application claims the benefit of U.S. provisional application No. 60/619,641 filed on Oct. 18, 2004, which is incorporated by reference as if fully set forth.

### FIELD OF INVENTION

The present invention is related to wireless communication systems. More particularly, the present invention is related to a method and system for suppressing unwanted responses in wireless communication systems.

### BACKGROUND

Wireless communication systems are using or evolving towards the use of directional antennas to increase range and capacity, reduce transmit power, and aid in locating terminals. In using directional antennas, many of the performance gains are based on the assumption that a signal is transmitted and received primarily through a main lobe (i.e., directional beam) of a radiated antenna pattern.

Antennas, however, radiate not only main lobes, but also sidelobes and backlobes for example. Receiving terminals that are close enough to the transmitter or have favorable enough propagation conditions can successfully receive signals through the sidelobes or backlobes of a radiated antenna pattern. In such situations, receiving terminals located in the direction of sidelobes or backlobes, even though unintended, may process the transmitted signal and respond to the received signal. Such situations may cause various problems such as, for example:

(1) interfering with reception of signals from terminals in the main lobe thereby reducing the performance benefits provided by directional antennas;

(2) causing a transmitting terminal to infer that the direction to a receiving station corresponds to the direction of the main lobe thereby causing errors in location processing;

(3) causing a transmitting terminal to infer that a receiving terminal requires greater transmit power, and as a result, increasing the transmit power to that receiving terminal thereby causing interference and degrading signal quality to intended receivers; and

(4) causing a transmitting terminal to process unnecessary responses thereby requiring greater processing capability.

Therefore, there is a need for a method and system for suppressing unwanted responses in wireless communication systems.

### SUMMARY

The present invention is a method and system for suppressing unwanted responses in wireless communication systems. The system comprises a transmitting terminal and a receiving terminal. The transmitting terminal comprises an antenna array including a primary antenna and a secondary antenna. The primary and secondary antennas are configured so that signals transmitted from the antennas are distinguishable to a receiving terminal. The receiving terminal comprises a receiver configured to receive signals transmitted from the antennas and compare a quality of the signals in order to determine whether a received signal was transmitted from within a main lobe of a beam of a primary antenna. The receiving terminal processes a received signal where it is determined that the received signal was transmitted from a main lobe of a beam of a primary antenna.

### BRIEF DESCRIPTION OF THE DRAWINGS

FIG. 1 is a diagram showing antenna patterns.

FIG. 2 is a diagram showing signal transmission between a transmitting terminal and a receiving terminal in accordance with the present invention.

FIGS. 3(a)-3(d) show two signals transmitted from two different antennas wherein the signals are configured to enable a receiving terminal to determine which signal was transmitted from which antenna so that the receiving terminal may only process signals transmitted within a main lobe of a desired antenna.

FIG. 4 is a flow diagram of a process for suppressing unwanted responses in wireless communication systems in accordance with the present invention.

### DETAILED DESCRIPTION OF THE PREFERRED EMBODIMENTS

The present invention is applicable to any type of wireless communication system, including, but not limited to, cellular systems, mobile systems, wireless LANs, MANs, and PANs, fixed access systems, and ad-hoc/mesh networks. The present invention is applicable to any wireless communication standard including, but not limited to, 1G through 3G cellular systems (e.g. AMPS, IS-136, GSM/GPRS/EDGE, IS-95, CDMA2000, UMTS FDD/TDD) and the 802.xx family (e.g. 802.11a/b/g/k, 802.16, 802.15, etc.).

Herein, a wireless transmit/receive unit (WTRU) includes but is not limited to a user equipment, mobile station, fixed or mobile subscriber unit, pager, or any other type of device capable of operating in a wireless environment. When referred to herein, a base station includes but is not limited to a Node-B, site controller, access point (AP) or any other type of interfacing device in a wireless environment.

Generally, in the present invention, a receiving terminal determines if a received signal was transmitted from a main lobe or a sidelobe of a primary antenna of a transmitting terminal. The receiving terminal does not send any responses to a received signal where it is determined that the received signal was not transmitted from a main lobe of a primary antenna of the transmitting terminal.

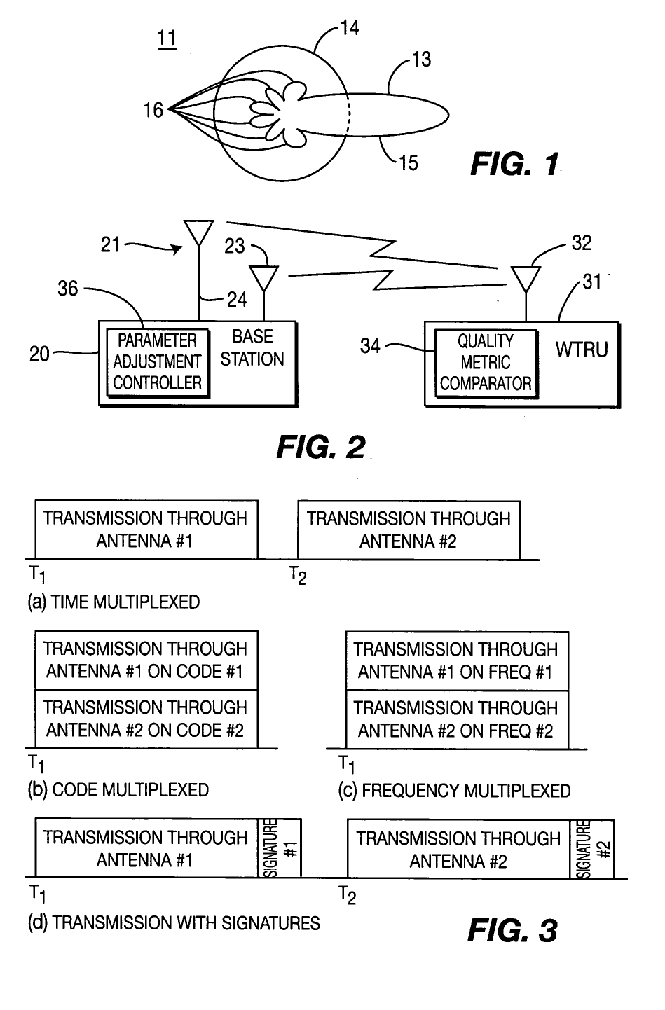

Referring initially to FIG. 1, a transmitting terminal provides antenna gain as a function of direction which can be represented by polar pattern plots. In FIG. 1, two plots 11 are shown, a directional antenna pattern 13 comprising a main lobe 15 plus sidelobes and backlobes 16 and an omni-directional antenna pattern 14. The so-called main lobe 15 is the high gain part of the directional antenna pattern. The sidelobes and backlobes 16 are scalloped low-gain sections that are not on the main lobe 15 of the directional antenna pattern. The sidelobes and backlobes 16 are undesirable, but unavoidable artifacts in real antennas. If a receiver is situated such that the main lobe is pointed in its direction, and equal power signals are input to both the antenna with the directional pattern 13 and the omni-directional pattern 14, the signal input to the directional antenna should be received with higher power. Alternatively, if a receiver is situated such that a sidelobe or backlobe is pointed in its direction, the signal input to the omni-directional antenna should be received with higher power.

For convenience in describing the present invention, a base station is assumed to be a “transmitting terminal” and a WTRU is assumed to be a “receiving terminal.” Of course, the transmitting terminal may also be a WTRU and a receiving terminal may be a base station or both the transmitting and receiving terminals may be WTRUs, such as in ad-hoc mode. Further, the term “sidelobe” is used, purely for convenience, to collectively refer to all lobes other than the main lobe (e.g. backlobes) of a radiated antenna pattern.

Referring now to FIGS. 1 and 2, a base station 20 according to the present invention generates a plurality of beam patterns using multiple transmit antennas, preferably arranged as two antennas 23, 24. The two antennas 23, 24 are a primary antenna 23 preferably providing gain over a directional beam and a secondary antenna 24 preferably providing gain over an omni-directional pattern. The antennas 23, 24 may be multiple physical antennas, an antenna array that can be configured for generating different beam patterns, or any configuration that allows the base station 20 to transmit at least two radiation patterns 13, 14. For purposes of clarity and understanding, the term “antenna” will be used, although in many cases an antenna array will provide the antenna function. In the example shown in FIG. 2, the antenna 21 is depicted as two separate antenna devices 23, 24, and each antenna device 23, 24 may include an antenna array of multiple antenna devices.

The primary antenna 23 generates a directional beam 13. The directional beam may be directional in azimuth, elevation, or any combination of the two. The secondary antenna 24 generates an (approximately) omni-directional pattern 14. A receiving terminal such as a WTRU 31 is provided and has one antenna 32 that receives transmissions from the base station 20.

According to one embodiment of the present invention, any transmissions from the base station 20 designed to elicit a response from a WTRU 31 are transmitted through both antennas 23, 24. There are at least two transmissions of the signal that may or may not be simultaneous, depending on the multiplexing scheme. The transmission format is designed such that the WTRU 31 knows which antenna each signal was transmitted from. The transmission format may be set up a priori, may be signaled periodically, or each transmission may contain information identifying which antenna 23, 24 the transmission was transmitted through.

Examples of methods that the base station 20 may use when transmitting signals in order to allow the WTRU 31 to determine which antenna was used include:

1) Time division multiplexing (FIG. 3(a));

2) Code division multiplexing (FIG. 3(b));

3) Frequency division multiplexing (FIG. 3(c));

4) Including signatures or bit patterns in each transmission that identify the transmit antenna (FIG. 3(d)); and

5) Any combination of the above.

Once the WTRU 31 receives a signal from antennas 23, 24 of base station 20, WTRU 31 preferably compares a quality metric for each received signal. The comparison of the quality metrics may be performed by a quality metric comparator 34. If the quality is higher for the signal received from the primary antenna 23, the WTRU 31 knows the received signal was transmitted within a main lobe of the antenna's 23 beam 13. In that case, the WTRU 31 processes the received signal and responds as appropriate. If the quality of the signal received from the primary antenna 23 is equal to or lower than the quality of the signal received from the secondary antenna 24, the WTRU 31 does not process or respond to the received signal.

The signals transmitted from the base station 20 may be, for example, a common, shared, or dedicated signal. In a preferred embodiment, a broadcast signal may be transmitted from both antennas 23, 24 of a base station 20 to all WTRUs associated with the base station 20. The WTRUs would only send a response where the quality comparison was positive thereby limiting the responses to a subset of WTRUs that may want to transmit.

It is noted that, in situations where a base station 20 is receiving too many responses (i.e. too many WTRUs have received the base station's 20 signal and responded thereto), the base station 20 may adjust various parameters (e.g. power, antenna gain, antenna pattern) so as to limit the number responses. Similarly, where necessary, the base station 20 may adjust parameters to increase the number of responses. The adjustment of parameters so as to maintain an appropriate or desired amount of responses is preferably performed by a parameter adjustment controller 36.

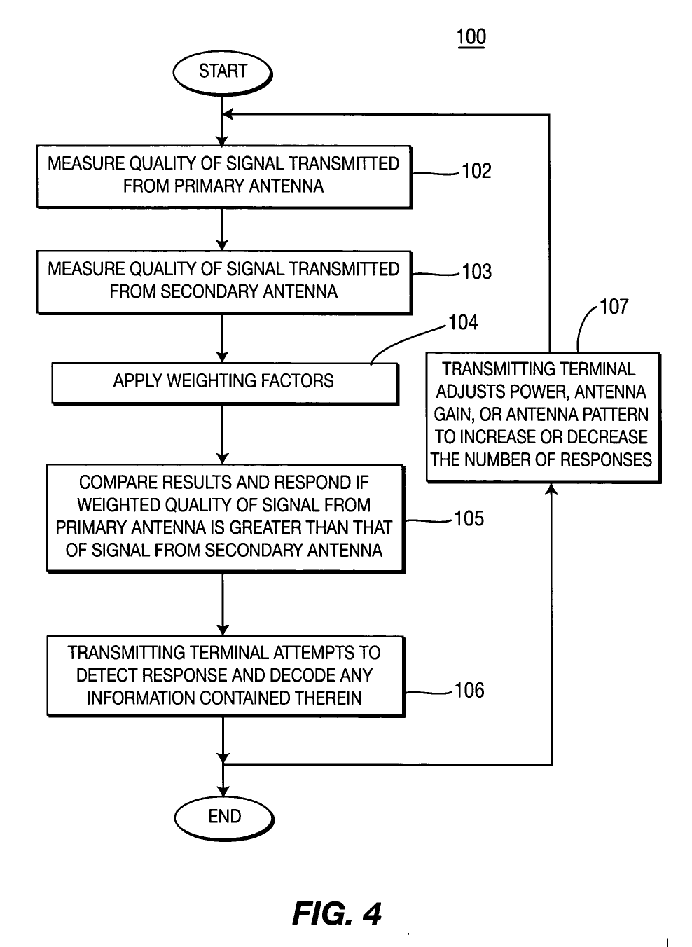

In a preferred embodiment, a receiving terminal executes a process 100 as shown in FIG. 4. The receiving terminal measures the quality of received signals from a primary and secondary antenna of a transmitting terminal (steps 102, 103). The measurement of quality in steps 102 and 103 employ quality metrics. Examples of quality metrics are: received power, signal-to-noise-ratio, presence or absence of a scheduled transmission. Optionally, the receiving terminal may apply weighting factors to the quality metrics (step 104). Weighting factors could bias the decision towards responding more often or less often (i.e., increasing or decreasing probability of responding or the probability of deciding that the receiving terminal is within the main lobe of the transmitter). The receiving terminal then compares the quality of the two signals and responds only if the quality of the signal from the primary antenna is better than the quality of the signal from the secondary antenna (step 105). The transmitting terminal then attempts to detect a response from one or more receiving terminals and decode any information contained therein (step 106).

If the transmitting terminal receives too many responses, system performance may be degraded for various reasons such as, for example: (1) If responses overlap in time, the mutual interference may limit the ability to discriminate among responses, detect their presence, or decode information they contain, or (2) The transmitting terminal may not have the processing capacity to handle all of the responses. Optionally, the transmitting terminal may exercise some control over the number of responses by adjusting the antenna pattern (e.g. beamwidth), antenna gain, or signal power transmitted through the primary or secondary antenna (step 107).

For example, if the transmitter receives too many responses, it may decrease the signal power into the directional antenna or the gain of the main lobe. Alternatively, or in combination with the above, the transmitter may adjust the antenna pattern (e.g. narrow the width of an antenna pattern's main lobe). Alternatively, or in combination with one or both of the above, the transmitter may increase the signal power or gain of the omni-directional antenna. Each of these actions would tend to decrease the quality of the received signal from the main lobe relative to that of the sidelobes, reduce the range and/or spatial angle over which the quality comparison would cause a WTRU to respond, and potentially reduce the number of WTRUs that respond.

If the transmitter receives too few responses, it may do one or more of the following: increase the signal power into the directional antenna or the gain of the main lobe, widen the width of the main lobe, or decrease the signal power or gain of the omni-directional antenna. Each of these actions would tend to increase the quality of the received signal from the main lobe relative to that of the sidelobes, increase the range and/or spatial angle over which the quality comparison would cause a WTRU to respond, and potentially increase the number of WTRUs that respond.

Referring to FIG. 1 and FIG. 4, step 104 allows the quality of the two signals 13, 14 to be weighted. That is, if Qₚ is the quality metric from the primary antenna and Qₛ is the quality metric from the secondary antenna then the receiver would compare WₚQₚ to WₛQₛ to determine whether or not to respond where Wₚ and Wₛ are weighting factors. For example, it may be known a priori that the omni-directional signal 14 is substantially weaker, such that a comparison of the directional signal 13 with the omni-directional signal 14 would have to be weighted in order for the comparison to have meaning. Such an arrangement, particularly in the case of a weaker omni-directional signal, would be advantageous because it would reduce the overall signal power a base station would need to transmit. This would be useful, for example, if the base station was also transmitting multiple directional signals and needed to limit the total transmitted power. Alternatively, the receiving terminal may apply different weights to set different nominal ranges for which it would reply. For example, the larger the weight applied to the signal from the primary antenna, the longer the range.

In one embodiment of the invention, the signals transmitted through both the primary and secondary antenna are common channel signals, “common” meaning that a signal may be received and processed by any WTRU. Alternatively, the transmitted signals may include shared channel signals, “shared” meaning that a signal may be received and processed by a particular subset of WTRUs. Alternatively, the transmitted signals may include dedicated channel signals, “dedicated” meaning that a signal may be received and processed by one particular WTRU. In the descriptions below, the term “common” will be used for both common and shared channel transmissions.

It would be advantageous to use weighted signals in instances where some signals are broadcast as common or shared signals and other signals are broadcast as dedicated signals. In such an arrangement, a dedicated signal can be transmitted at reduced power because of a close proximity of a particular WTRU or other receiving terminal 31 to a base station 20 (FIG. 2). The broadcast common signal would have to be transmitted at sufficient strength to reach all receiving terminals deemed to be within a given broadcast area or cell. In such a case, there is no option to reduce the power of the omni-directional signal 14 if one WTRU is within close proximity, because other WTRUs would be more distant.

This adjustment of the directional and omni-directional signals 13, 14 would typically apply in a way that would permit changing power for the directional signal 13 because the directional signal would be the dedicated signal. In a multiuser system, it is common to adjust the signal strength of a dedicated signal in order to provide sufficient signal strength to distant WTRUs and reduce the power provided to WTRUs which are close to a base station. This reduces power consumption, but also improves overall signal quality in a network by reducing the total power transmitted by a base station where all but the intended signal acts as interference. Similarly, the uplink signal from the WTRU 31 to the base station 20 is adjusted in power, thereby reducing power consumption and to some extent reducing noise. Therefore, if the omni-directional signal 14 is a common broadcast signal, there will be a variation in the relative signal strengths between the directional signal 13 and the omni-directional signal 14.

If the power applied on dedicated channels is to be compared with power on a common broadcast channel, it is necessary to provide the WTRU with a value for the relative signal strengths. This permits the WTRU to weight the signals and thereby use the relative signal strengths to determine whether reception is on the main lobe. The power of the dedicated and common channels, or the relative power, may be included as data in a signal transmitted by the base station 21 to the WTRU 31. It may, for example, be part of a power control signal provided by the base station 21 to the WTRU 31.

The transmission from the transmitting terminal may be repeated more than once through each antenna. The number of repetitions need not be equal on each antenna. It may be desirable to transmit the signal through the primary antenna more times to increase its probability of detection and/or extend the transmission range. It may be desirable to transmit the signal through the secondary antenna more times to increase its probability of detection and/or improve the ability of the receiver to determine if a received transmission was in the main lobe of the primary antenna. A base station may, for example, transmit the signal through either antenna multiple times as a means to reduce the power required for each transmission. The receiving terminal would process the repeated signals in computing the quality metrics.

In a preferred embodiment of the present invention, signals sent from a secondary antenna 24 may be limited to a preamble portion (i.e. a sufficient amount of the signal to enable a receiving terminal to compute a quality metric for comparison to a quality metric from a primary antenna 23). This embodiment reduces network traffic and the amount of processing required when receiving a signal from both a primary and secondary antenna 23, 24.

The system is described herein using a primary directional beam and a secondary omni-directional pattern; however, the secondary pattern may be any arbitrary shape. For example, in some deployments, the secondary pattern may be a hemisphere, semi-circle, or a sum-difference pattern.

The transmitting terminal may generate more than two signal patterns, such as:

1) A high gain direction beam, a medium gain beam, and a low gain omni-directional pattern;

2) A high gain beam and two semi-circular (or hemispherical) patterns; and/or

3) Any combination of directional and broad patterns.

The receiving terminal implements logic that decides among the proper number of alternatives. The present invention was described using a primary directional beam and one or more secondary patterns that are broader than the primary beam; however, the secondary pattern may also be a directional beam. It is also noted that the antenna patterns may change with time. For example, electrical scanning, mechanical scanning, beam forming, or adaptive arrays may be utilized. If the antenna pattern changes with time, the processes described, such as that in FIG. 4, would apply to signals transmitted through a particular pattern at one or more particular times.

Although the elements in the Figures are illustrated as separate elements, these elements may be implemented on a single integrated circuit (IC), such as an application specific integrated circuit (ASIC), multiple ICs, discrete components, or a combination of discrete components and IC(s). Although the features and elements of the present invention are described in the preferred embodiments in particular combinations, each feature or element can be used alone without the other features and elements of the preferred embodiments or in various combinations with or without other features and elements of the present invention. Furthermore, the present invention may be implemented in any type of wireless communication system.

What is claimed is:

1. In a wireless communication system comprising one or more base stations, for communication with a plurality of wireless transmit and receive units (WTRUs), whereby transmissions to the WTRUs include a directional component, a system to reduce responses from sidelobe transmissions, the system comprising:
a directional component of a communication signal; and
a component of a communication signal having reduced directional characteristics as compared to the directional component, the directional component and the component having reduced directional characteristics transmitted at signal strengths within predetermined limits of relative power, whereby a comparison of the signal strengths provides an indication of reception of the directional component in a main lobe by a WTRU.

2. The communication system of claim 1 comprising the directional component providing dedicated communications to the particular WTRU while aligned with a determined direction of signal propagation for transmission to the particular WTRU.

3. The communication system of claim 1 comprising the directional component providing communications to a plurality of WTRUs while aligned with a determined direction of signal propagation for transmission to the plurality of WTRUs.

4. The communication system of claim 3 wherein the communications are transmitted by a base station over a channel which WTRUs monitor when determining whether to make an access attempt.

5. The communication system of claim 1 comprising the directional component providing dedicated communications to the particular WTRU as a non-scanning signal.

6. The communication system of claim 1 comprising one of the directional component and the component having reduced directional characteristics providing weighting data for the comparison of the signal strengths to provide an indication of reception of the directional component in a main lobe by the WTRU.

7. The communication system of claim 1 comprising a power control signal providing weighting data for the comparison of the signal strengths to provide an indication of reception of the directional component in a main lobe by the WTRU.

8. In wireless communication system comprising one or more base stations, for communication with a plurality of wireless transmit and receive units (WTRUs), whereby transmissions to the WTRUs include a directional component, a WTRU to reduce responses from sidelobe transmissions, the WTRU comprising:
a circuit for receiving a directional component of a communication signal; and
a circuit for receiving a component of a communication signal having reduced directional characteristics as compared to the directional component, the directional component and the component having reduced directional characteristics being transmitted at signal strengths within predetermined limits of relative power, whereby a comparison of the signal strengths provides an indication of reception of the directional component in a main lobe by the WTRU.

9. The WTRU of claim 8 comprising:
a circuit responsive to a power control signal providing weighting data for the comparison of the signal strengths to provide an indication of reception of the directional component in a main lobe by the WTRU and generating a weighted value for comparison of the signal strengths between the directional component and the component of the communication signal having a reduced directional characteristic; and
a comparison circuit to compare the weighted value for comparison of the signal strengths between the directional component and the component of the communication signal having a reduced directional characteristic and provide an indication of reception of the directional component in a main lobe, whereby said comparison of the signal strengths provides an indication of reception of the directional component in a main lobe.

10. The WTRU of claim 8 comprising the directional component providing dedicated communications to the particular WTRU, which the WTRU receives as a non-scanning signal.

11. The WTRU of claim 8 comprising the directional component providing communications to a plurality of WTRUs, which the WTRUs receive as a directional pattern that changes with time.

12. The WTRU of claim 8 comprising one of the directional component and the component having reduced directional characteristics providing weighting data for the comparison of the signal strengths to provide an indication of reception of the directional component in a main lobe by the WTRU.

13. In a wireless communication system comprising one or more base stations, for communication with a plurality of wireless transmit and receive units (WTRUs), whereby transmissions to the WTRUs include a directional component, a system to reduce response for sidelobe transmissions, the system comprising:
a directional component of a communication signal;
a component of the communication signal having reduced directional characteristics as compared to the directional component, the directional component and the component having reduced directional characteristics transmitted at signal strengths within predetermined limits of relative power;
a power control circuit function configured to control a signal level of the directional component of the communication signal;
a circuit configured to generate a weighted value for comparison of the signal strengths between the directional component and the component of the communication signal having a reduced directional characteristic; and
a comparison circuit to compare the weighted value for comparison of the signal strengths between the directional component and the component of the communication signal having a reduced directional characteristic, whereby said comparison of the signal strengths provides an indication of reception of the directional component in a main lobe by the WTRU.

14. The communication system of claim 10 comprising the directional component providing dedicated communications to the particular WTRU while aligned with a determined direction of signal propagation for transmission to the particular WTRU.

15. The communication system of claim 10 comprising the directional component providing communications to a plurality of WTRUs while aligned with a determined direction of signal propagation for transmission to the plurality of WTRUs.

16. The communication system of claim 13 comprising the directional component providing dedicated communications to the particular WTRU as a non-scanning signal.

17. The communication system of claim 13 comprising the directional component providing communications to a plurality of WTRUs, which the WTRUs receive as a directional pattern that changes with time.

18. The communication system of claim 13 comprising one of the directional component and the component having reduced directional characteristics providing weighting data for the comparison of the signal strengths to provide an indication of reception of the directional component in a main lobe by the WTRU.

19. A wireless communication system for suppressing sidelobes, the system comprising:
a transmitting terminal comprising:
an antenna array for generating a primary beam and a secondary beam; and
means for transmitting signals via the primary beam and the secondary beam while incorporating information in the signals for distinguishing between the primary beam and the secondary beam; and
a receiving terminal comprising:
means for receiving signals and comparing a quality of the signals; and
means for responding to the transmitting terminal if a signal received from the primary beam is better than a signal received from the secondary beam.

20. The system of claim 19 wherein the transmitting terminal is a base station.

21. The system of claim 19 wherein the receiving terminal is a wireless transmit/receive unit (WTRU).

22. An integrated circuit device comprising:
a circuit for receiving a directional component of a communication signal; and
a circuit for receiving a component of a communication signal having reduced directional characteristics as compared to the directional component, the directional component and the component having reduced directional characteristics being transmitted at signal strengths within predetermined limits of relative power, whereby a comparison of the signal strengths provides an indication of reception of the directional component in a main lobe.

23. An integrated circuit device comprising:
a power control circuit function configured to control a signal level of a directional component of a communication signal; and
a circuit configured to generate a weighted value for comparison of the signal strengths between the directional component and a component of the communication signal having a reduced directional characteristic.

24. The integrated circuit device of claim 23 wherein the power control circuit is further configured to adjust a beamwidth of a directional component of a main lobe of a communication signal.

25. The integrated circuit device of claim 23 wherein the power control circuit is further configured to adjust the power of the component of the communication signal having a reduced directional characteristic.
